(19) United States
(12) Patent Application Publication
(10) Pub. No.: US 2006/0225108 A1
(43) Pub. Date: Oct. 5, 2006

(54) System and method for interactivity between mobile stations and a television device

(75) Inventors: Ali Tabassi, Great Falls, VA (US); Sanjay Khurana, Oakton, VA (US); Beverly Ann Murdock, Leesburg, VA (US); Greg Homan, Dallas, TX (US)

Correspondence Address: CROWELL & MORING LLP;INTELLECTUAL PROPERTY GROUP, P.O. BOX 14300, WASHINGTON, DC, 20044-4300, US

(73) Assignee: NEXTEL COMMUNICATIONS, INC., Reston, VA (US)

(21) Appl. No.: 11/191,946

(22) Filed: Jul. 29, 2005

Related U.S. Application Data
(60) Provisional application No. 60/667,076, filed on Apr. 1, 2005.

(51) Int. Cl. H04N 5/44; H04N 7/173

(52) U.S. Cl. 725/100; 725/131; 348/725

(57) ABSTRACT

A system and method for communicating between a television device and one or more mobile stations are provided. The television device can obtain a map identifying the location of the one or more mobile stations, which can be displayed on a television. The television device can also be used to provide dispatch communications with the one or more mobile stations. The one or more mobile stations can be part of a predefined group, such as a family. A group communication server is provided to facilitate communication between the television device and the one or more mobile stations.

The present application claims priority under 35 U.S.C. § 119 to U.S. Provisional Application No. 60/667,076, filed Apr. 1, 2005, the entire disclosure of which is herein expressly incorporated by reference.

### BACKGROUND OF THE INVENTION

Broadcast television has made tremendous advances over the past half century. Whereas broadcast television originally provided analog black and white video, digital high definition video is now provided. The mechanisms for delivering broadcast television have expanded from over the air reception to include reception from cable or satellite providers. In an effort to increase revenues, cable providers have made considerable investment in interactive services. Because people are familiar with using a television remote, interactive services typically are more user-friendly than providing similar services on a computer. Additionally, due to the high penetration rate of televisions, they provide an ideal medium for reaching large numbers of people.

Technology advancements in broadcast video networks, such as cable networks, have been slowed by the fact that the broadcast video network head-end, i.e., where the video is broadcast from, and the television devices, such as set top boxes, have been implemented using proprietary technology. In order to increase the development of services and applications for cable networks, the cable industry has developed the OpenCable Application Platform (OCAP), which allows applications and services to be deployed across any cable network, with minimal modification.

Similar to broadcast television, wireless communications, such as cellular telephone communications, have also experienced tremendous development, moving from a service used mainly by the wealthy to a service which is affordable for most people. Although both broadcast television and wireless communications have both made incredible advances, these technologies typically operate independent of each other. However, because broadcast television and wireless communications are employed by so many people, it would be desirable to provide interactivity between the two technologies.

### SUMMARY OF THE INVENTION

The present invention relates to systems and methods for providing interactivity between television devices and mobile stations. In accordance with the present invention, a television device can obtain information regarding the location of one or more mobile stations, and display a map identifying the location of the one or more mobile stations. Additionally, the television device can be used for dispatch communications, electronic mail, and multimedia messaging with mobile stations. The television device can be a component external to a television, or it can be integral to the television.

The communication between the television device and mobile stations is facilitated by a group communication server. The television device is coupled to a broadcast network head-end. The broadcast network head-end couples the television device to the group communication server via the Internet. The group communication server is coupled to a wireless network, a mapping server and electronic mail and other messaging servers via the Internet.

Accordingly, the present invention provides systems and methods for interaction between broadcast video and wireless communication technologies, thereby resulting in a service that leverages the large penetration of both markets. Additionally, the end-user experience is enhanced due to the ease of use provided by using television remote control to access the location of mobile stations, and communicate with mobile stations.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of an exemplary network for providing interactivity between a video broadcast network and a wireless communication network in accordance with the present invention;

FIG. 2 is a block diagram of an exemplary television device in accordance with the present invention;

FIG. 3 is a block diagram of an exemplary group communication server in accordance with the present invention;

FIG. 4 illustrates an exemplary message flow for television device registration in accordance with the present invention;

FIG. 5 is a block diagram of an exemplary system for delivering text messages between a television device and a mobile station in accordance with the present invention;

FIG. 6 illustrates an exemplary message flow for notifying a television device of an incoming message in accordance with the present invention;

FIG. 7 illustrates an exemplary message flow for sending a message from a television device in accordance with the present invention;

FIG. 8 illustrates an exemplary message flow for identifying a location of a mobile station to a television device in accordance with the present invention;

FIG. 9 illustrates an exemplary message flow for notifying a television device of an incoming dispatch communication in accordance with the present invention;

FIG. 10 illustrates an exemplary message flow for initiating a dispatch communication from a television device in accordance with the present invention;

FIG. 11 illustrates an exemplary message flow for notifying a television device of an incoming dispatch call alert in accordance with the present invention;

FIG. 12 is a block diagram of an exemplary software architecture of a television device in accordance with the present invention;

FIG. 13 is an exemplary graphical user interface for communicating information between a television device and a mobile station in accordance with the present invention; and

FIGS. 14a-14c are flow charts illustrating an exemplary method for communicating information between a television device and a mobile station in accordance with the present invention.

### DETAILED DESCRIPTION OF THE PREFERRED EMBODIMENTS

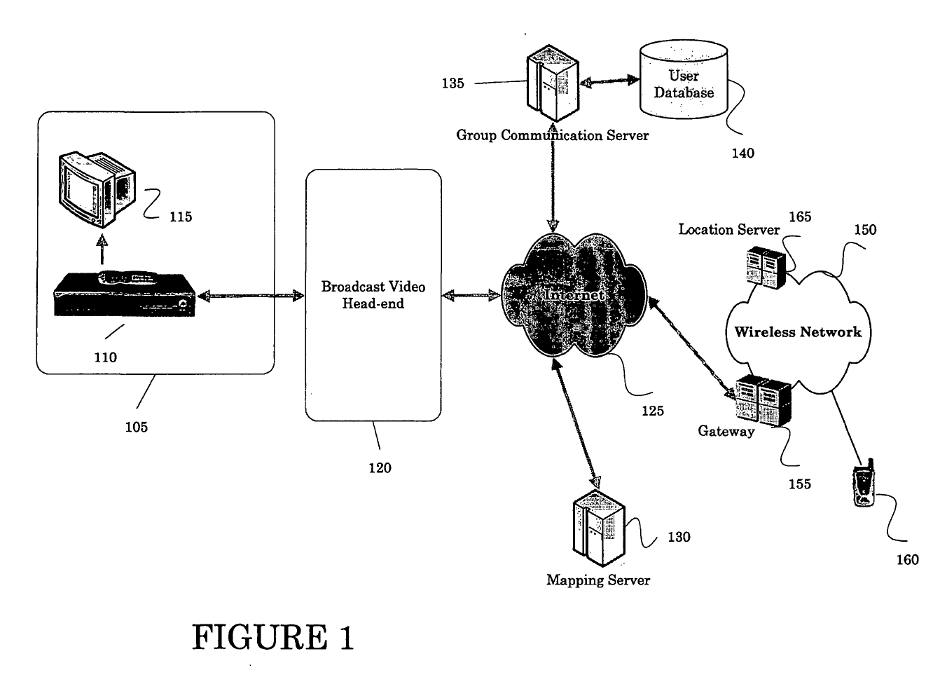

FIG. 1 is a block diagram of an exemplary network for providing interactivity between a video broadcast network and a wireless communication network in accordance with the present invention. The network includes one or more customer premises 105 coupled to a broadcast video head-end 120, such as a cable network head-end. Each customer premises includes a television device 110 coupled to a television 115. Although the television device 110 is illustrated as being a component external to the television 115, the television device 110 can be an integral component of the television 115.

The broadcast video head-end 120 is coupled to a mapping server 130, group communication server 135 and a wireless network 150 via the Internet 125. The broadcast video head-end and the group communication server 135 are coupled to the wireless network 150 via one or more gateways 155. The wireless network 150 supports communications for one or more mobile stations 160, and includes a location server 165. The location server 165 is used for determining the location of a mobile station. Specifically, the location server 165 can send a location request to the mobile station. If the mobile station is not involved in a voice or data communication, the mobile station can determine its location, e.g., using GPS or any other type of triangulation procedure, and forward its location back to the location server 165. If the mobile station is involved in a voice or data communication, the location server can determine the mobile station's location using the location of the base site currently supporting the mobile station.

In order to provide services to television device 110, the group communication server includes a user database 140, which stores information for each subscriber to the group communication services, where each subscriber corresponds to a particular television device 110. In accordance with exemplary embodiments of the present invention, the group communication services includes identifying a location of one or more mobile stations to a user of the television device 110, and text, voice and/or video communications between one or more mobile stations and a user of television device 110.

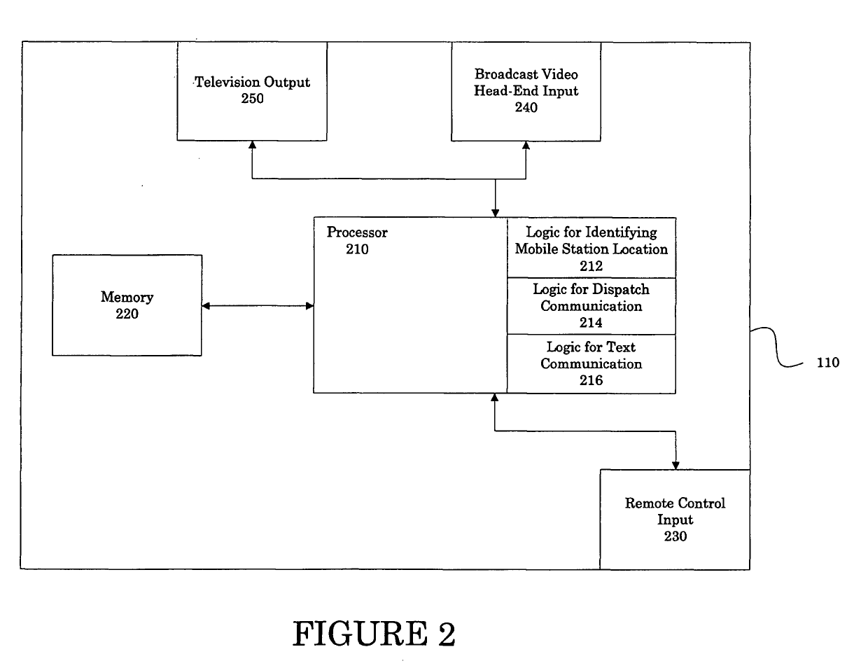

FIG. 2 is a block diagram of an exemplary television device 110 in accordance with the present invention. The television device 110 includes a processor 210, memory 220, remote control input 230, broadcast video head-end input 240 and television output 250. The processor can be a microprocessor, field programmable gate array (FPGA), application specific integrated circuit (ASIC), or the like. The processor 210 includes logic for identifying a mobile station location 212, logic for dispatch communications 214, and logic for text communications 216. The aforementioned logic of processor 210 will be used for providing the corresponding functionality described in more detail below.

The memory can be random access memory, read only memory, flash memory, a hard disk, or the like. The remote control input 230 can send and receive information to/from a remote control device via a wired or wireless communication medium, such as infrared or radio frequency technologies. The broadcast video head-end input 240 can be a coaxial cable input, copper wire input (e.g., for a digital subscriber line), fiber optic input, fixed wireless input (including terrestrial and satellite wireless) and/or the like, and is used to transmit and receive information between the television device 110 and the broadcast video head-end 120. The television output 250 can be coaxial, RCA, component, composite, DVI, or the like.

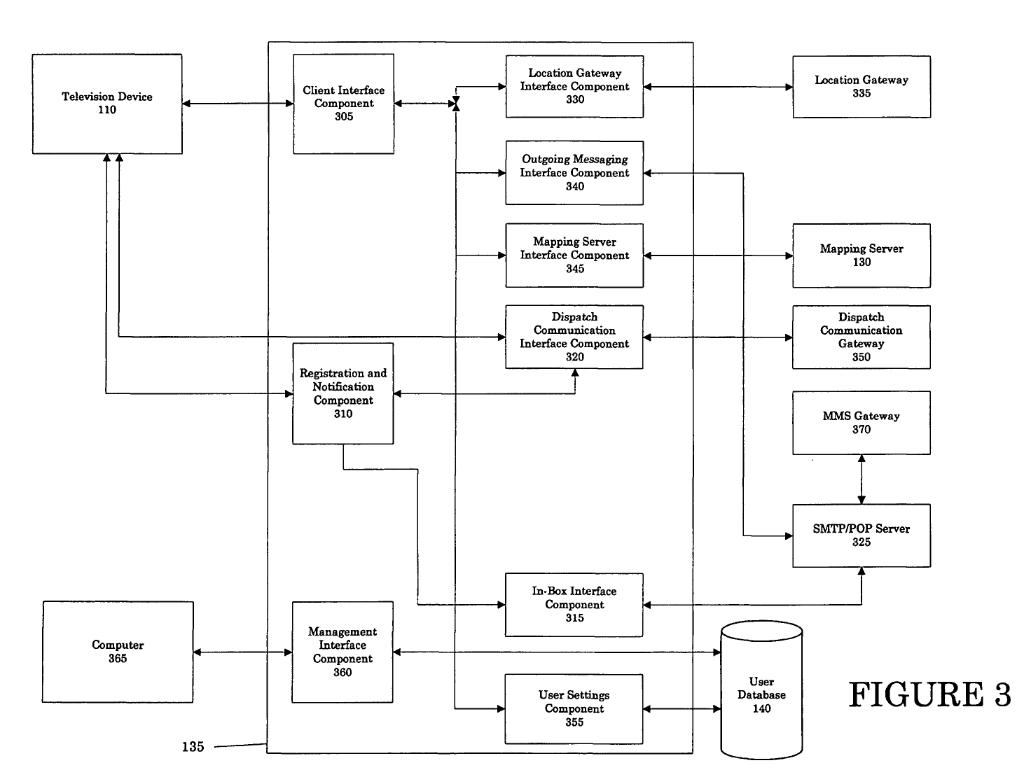

FIG. 3 is a block diagram of an exemplary group communication server 135 in accordance with the present invention. The television device 110 is coupled to a client interface component 305 and registration and notification component 310 of the group communication server 135. The client interface component 305 implements the protocol for communicating between the television device 110. Specifically, the client interface component 305 handles television device requests, delegates the requests to the appropriate downstream component, and upon completion of the request processing, sends back the response to the television device 110. In accordance with exemplary embodiments of the present invention, the protocol for communicating with the television device is based on HTTP with an XML content body. Because the television device 110 may be located behind a firewall, the client interface component 305 can implement symmetric RTP signaling.

The following table illustrates exemplary messages handled by the client interface component 305.

TABLE 1

| Television Device | | |
|---|---|---|
| Request Type | Request Components | Response Components |
| Group member | Telephone numbers for | Longitude, Latitude and |
| location retrieval | each mobile station | Accuracy for each mobile |
| | | station |
| Map retrieval | Longitude, Latitude and | URL of map image |
| | Zoom | |
| Address Directory | Television device ID | List of Address Directory |
| list retrieval | | entries and contact info |
| Predefined | Television device ID | List of audio clips used |
| objects retrieval | | for dispatch |
| | | communication |
| Sending of | Television device ID, | Indication of whether |
| MMS and 2-Way | Target address and text | message was sent |
| messages | message content | properly |
| Forwarding of | Television device ID, | Indication of whether |
| MMS and 2-Way | Target address, Message | message was forwarded |
| messages | ID to forward, and any | properly |
| | additional text message | |
| | content | |
| Inbox message | Television device ID | Content of message or list |
| retrieval | Message ID to retrieve | of messages with subject |
| | or empty to retrieve | lines |
| | complete list | |
| Deletion of Inbox | Television device ID, | Indication of whether |
| messages | Message ID to delete | message was deleted |
| Send Audio | Television device ID, | Indication of whether call |
| | Call ID, Target address, | has been placed, Call ID |
| | Audio clip ID to play to | and Media Address/port |
| | mobile | |
| Acknowledge | Television device ID, | Indication that the call |
| Call | Call ID | has been acknowledged |
| Outgoing call | Television device ID, | Indication of whether |
| alert | Target address | alert was sent |
| | | successfully |

As illustrated in Table 1, exemplary embodiments of the present invention allow television device 110 to transmit stored audio clips for use with dispatch communications. This reduces the costs of the television device 110, as it does not require a microphone to support voice communications. The stored audio clips can be recorded using a computer or an interactive voice response system, or can be predefined by the network operator. However, the television device of the present invention can include a microphone to allow for two-way interactive voice communications with mobile stations.

The registration and notification component 310 sends notifications to the television device 110. These notifications can be provided to the user of the device as video and/or audio notifications. The notifications include the arrival of new multimedia service (MMS) or 2-Way messages, receipt of a dispatch call or a dispatch call alert, floor status and call status (in the context of a dispatch call), and account configuration changes. In order to receive notifications from the registration and notification component 310, the television device 110 registers with the group communication server 135, and keep its registration alive. The registration and notification 310 communicates with the television device 110 using a registration and notification protocol (RNP) protocol which is based on XML over user datagram protocol (UDP). All notifications are confirmed with a notification response from the television device 110 back to the group communication server 135. The group communication server 135 retransmits the original notification until either a timeout or the notification response has been received. The following table illustrates exemplary notification messages.

TABLE 2

| Television Device | |
|---|---|
| Notification Type | Notification Components |
| Inbox | Number of unread message in the in-box |
| Incoming Dispatch Call | Call ID, Caller ID, and Media (IP) |
| | Address/port |
| Incoming Call Alert | Caller ID |
| Floor Open | Call ID |
| Floor Taken | Call ID and ID of current floor owner |
| Call Ended | Call ID |

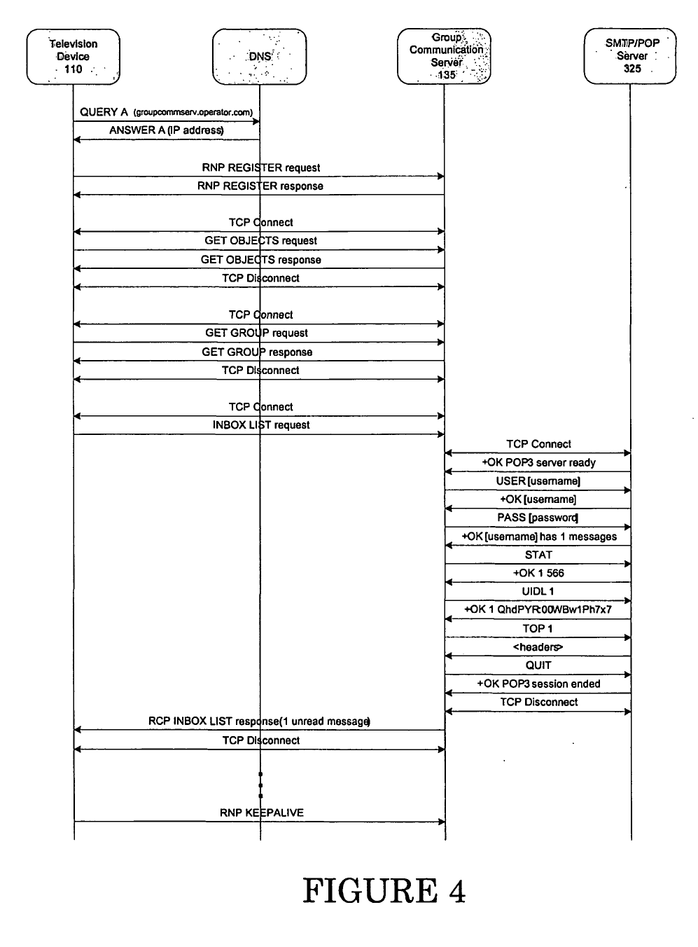

FIG. 4 illustrates an exemplary message flow for the registration of the television device 110 in accordance with the present invention. The processor 210 of television device 110 sends a DNS query to discover the IP address of the group communication server 135. The processor 210 of television device 110 then sends an RNP REGISTER request, including the television device ID, over UDP to the group communication server 135. The group communication server 135 sends a response containing the location of the registration and notification component 310 of the group communication server 135, the expiration time of the registration, as well as other registration information. This registration occurs on the same UDP port where the television device 110 is listening for notifications. The television device 110 must re-register with the group communication server 310 before the registration expiry time or it no longer receives notifications.

The processor 210 of television device 110 establishes a TCP connection with the group communication server 135, and a signal request/response pair is sent over a TCP connection using HTTP. The television device 110 then sends a GET OBJECTS request to the group communication server 135 to obtain information about the pre-defined objects on the server, which provides a response to the request. The predefined objects are audio clips that can be sent during a dispatch call. The television device 110 then sends a GET GROUP request to the group communication server 135 to obtain a list of group members and their addresses, i.e., mobile stations and associated calling identifiers.

The television device 110 queries the group communication server 135 for any unread messages in the in-box using the INBOX LIST request. The group communication server 135 connects to the SMTP/POP server 325 and authenticates itself as the user of television device 110. The group communication server 135 then obtains the list of messages and message IDs.

If any message IDs are not in the user database 140 as being retrieved, then the group communication server 135 includes them in the list of messages sent back to the television device 110. Specifically, user database 140 includes a ‘Message Notified Table’, which lists the messages for which the television device 110 has already received a notification. The group communication server 135 sends a response to the television device 110, which includes the list of unread messages to the television device 110. Specifically, the list includes the header information and unique message ID of each message. The television device 110 can provide an indication to the subscriber that an unread message has been received.

Because the television device 110 may be located behind a firewall, the television device 110 periodically sends a KEEP ALIVE over the UDP to the group communication server 135 in order to keep the UDP channel open for notifications. The keep alive request contains the television device ID so that the group communication server 310 can determine if the reverse address and port have changed for that television device 110. In accordance with exemplary embodiments of the present invention, a keep-alive message comprises a short XML body which yields very fast processing on the group communication server 135.

Returning now to FIG. 3, at predefined intervals, the in-box interface component 315 is used by the client interface component 305 to list and retrieve in-box messages and missed dispatch calls upon request by the television device 110, and by the registration and notification component 310 to list new messages for notifying the television device 110 of newly received messages. The in-box interface component 315 does not automatically delete an e-mail message after downloading it. Instead, the SMTP/POP server 325 itself provides persistent storage for incoming messages. To permanently delete messages from the SMTP/POP server 325, the television device 110 must issue a delete message request.

The in-box interface component 315 can access a ‘Message List Table’ in the user database 140, which stores a list of unique message IDs present in the in-box of the account. Each message present in the in-box is identified using its unique ID specified in the POP3 protocol. An attribute of ‘read/unread’ is also stored in the ‘Message List Table’ indicating if the television device 110 has downloaded (read) a specific message.

The in-box interface component 315 is also responsible for retrieving information regarding missed dispatch calls. The information regarding these calls is stored in the SMTP/POP server 325. The e-mail regarding a missed dispatch call or dispatch call alert is sent by the registration and notification component 310 to the user's e-mail account when a dispatch call is received for a television device 110 which is not currently registered or is not acknowledging the notification from the server.

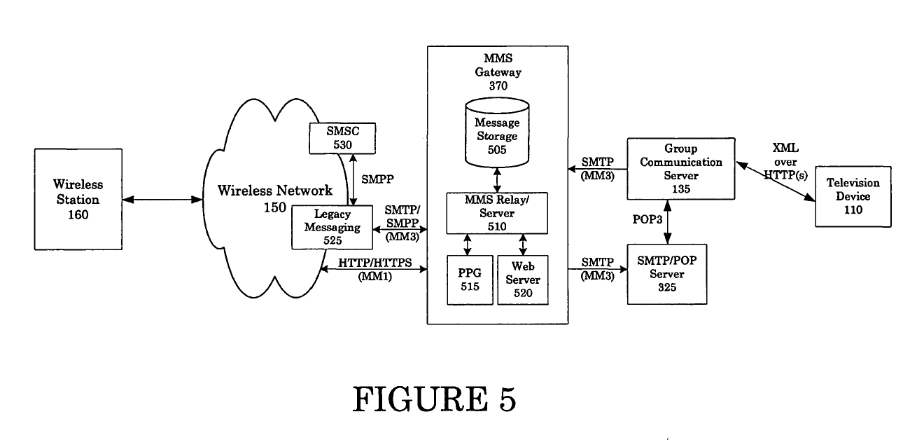

FIG. 5 is a block diagram of an exemplary system for delivering text messages between a television device and a mobile station in accordance with the present invention. The television device 110 communicates text messages to the group communication server 135 using XML over HTTP(s). The group communication server sends outgoing messages to SMTP/POP server 325 using POP3 protocol. The group communication server 135 sends outgoing text messages to the MMS gateway 370 using SMTP protocol, which in the context of MMS messaging is also known as the MM3 interface. The MMS gateway 370 forwards text messages destined for television device 110 to SMTP/POP server 325 using SMTP protocol.

The MMS gateway includes message storage 505, MMS relay/server 510, push proxy gateway (PPG) 515 and web server 520, all of which operate according in a conventional manner. For wireless stations 160 which support MMS, the MMS gateway will communicate with the wireless station using HTTP or HTTPS, which is also known in the context of MMS messaging as the MM1 interface. The MMS gateway 370 can also support text messaging with wireless stations which do not support MMS messaging. Specifically, wireless stations which support short message service (SMS) messaging can communicate text messages with SMSC 530, which communicates the text messages with legacy messaging interface 525. Legacy messaging interface 525 can communicate with MMS gateway 470 using SMTP/SMPP.

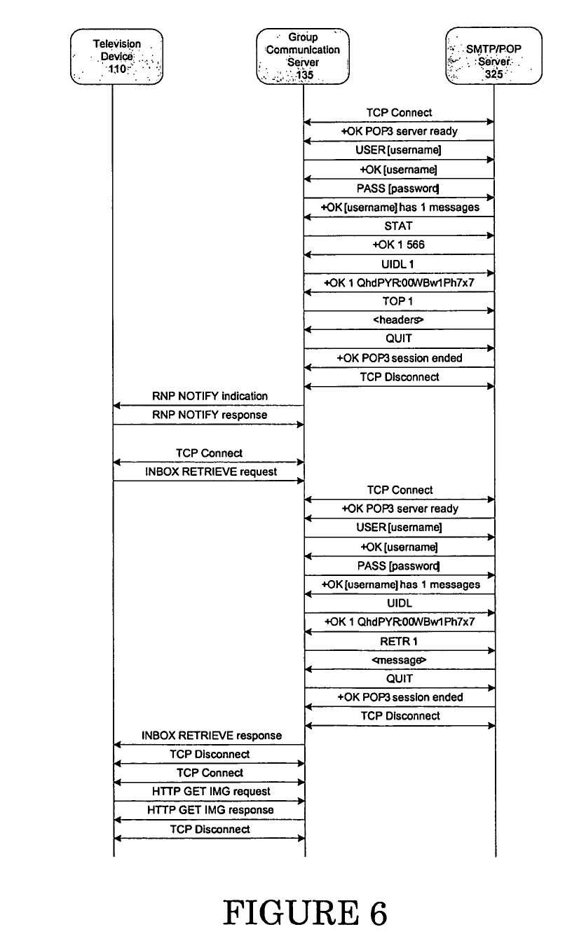

FIG. 6 illustrates an exemplary message flow for an incoming message notification to the television device 110 in accordance with the present invention. Periodically, the registration and notification component 310 of the group communication server 135 opens a connection to the SMTP/POP server 325 and authenticates itself as the user of television device 110. The group communication server 135 uses the POP3 protocol and the ‘Message Notified Table’ to determine if any new messages have arrived at the SMTP/POP server 325.

Once the group communication server 135 determines a new message has arrived, it will populate the ‘Message List Table’ with new entries (messages which were not previously listed), if any, and mark these messages as unread. The group communication server 135 will then send an RNP NOTIFY indication to the television device 110. If the television device 110 responds, the message is no longer considered new, and the group communication server 135 adds the message ID to the ‘Message Notified Table’.

The subscriber may chose to respond to the notification by reading the message. In that case the television device 110 sends a INBOX RETRIEVE request to the group communication server 135. The group communication server 135 connects to the SMTP/POP server 325 and retrieves the message. The group communication server 135 sends the complete message as an INBOX RETRIEVE response with any attachments sent as URLs. The television device 110 can retrieve any attachments using the URLs in the INBOX RETRIEVE response. The in-box interface component 315 tags every message sent back to the television device 110 as ‘read’ or ‘unread’ according to the ‘Message List Table’ entries. When the television device 110 downloads the content of a message, it tags the message as read in the ‘Message List Table’. The television device 110 can download or delete a particular message by referencing the unique message ID of the message. When a message is deleted the corresponding ‘Message List Table’ entry is also deleted.

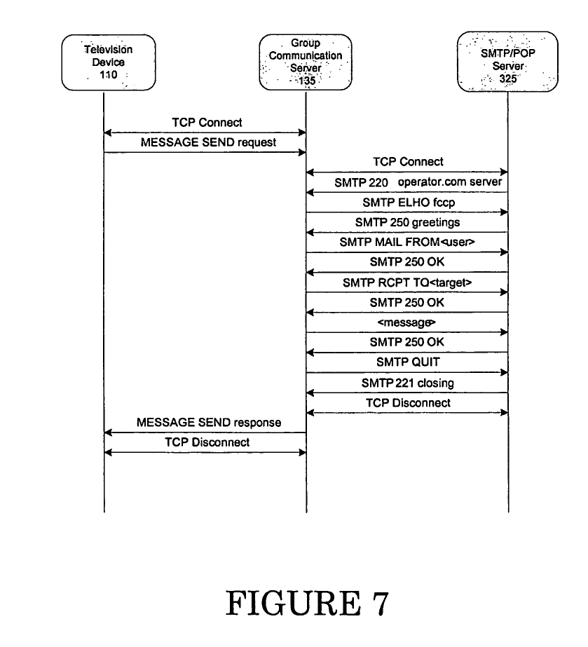

FIG. 7 illustrates an exemplary message flow for sending an outgoing message from the television device 110 in accordance with the present invention. When the subscriber wants to send an outgoing message, the television device 110 connects to the group communication server 135 and places the message in a MESSAGE SEND request. The outgoing messaging interface component 340 of the group communication server 135 opens a connection to the SMTP/POP server 325 and establishes the source and destination of the message. The outgoing messaging interface component 340 of the group communication server 135 then sends the content of the messages, along with any attachments to the SMTP/POP server 425 and closes the connection. The group communication server 135 responds to the television device 110 with a MESSAGE SEND response indicating that the message was successfully sent.

Returning now to FIG. 3, the location gateway interface component 330 handles television device 110 requests and responses and implements the mobile location protocol to interface with the location gateway 335, which is a component of wireless network gateway 155. The mapping server interface component 345 facilitates the retrieval of geographical maps upon request from the television device 110. The mapping server 130 can be a web server which can provide a GIF image based on the receipt of latitude and longitude coordinates for the center of the map, map scale, and map image size parameters. Alternatively, the mapping server can be a component of the wireless network 150.

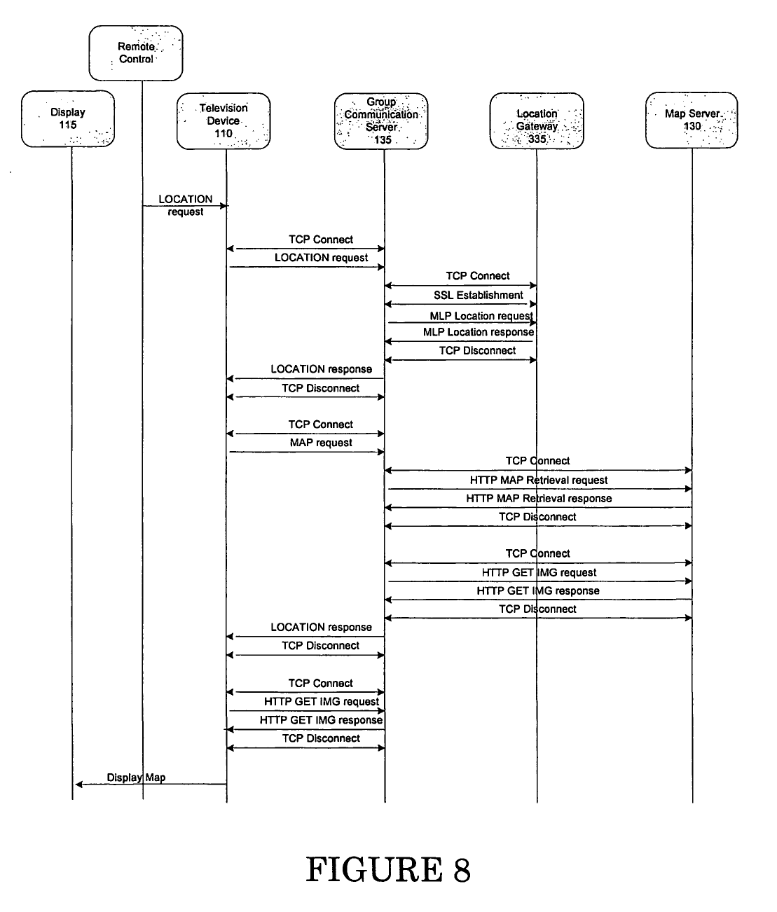

FIG. 8 illustrates an exemplary message flow when the television device 110 requests the location of a mobile station in accordance with the present invention. Initially, the processor 210 of the television device 110 receives a location request for one or more mobile stations from the remote control input 230. The remote control input 230 will receive a location request as a select command and it is interpreted as a location request when the select command is received and a graphical user interface has either a mobile station, a group of mobile stations, or a location request element highlighted. The processor 210, based on information stored in memory 220, sends a LOCATION request to group communication server 135. Specifically, the location request is sent to the group communication server 135 via broadcast video head-end 120 and the Internet 125.

Upon receiving a request from the television device 110 to retrieve the location of a group member, the location gateway interface component 330 retrieves the phone number of the group member from the request, and checks the user database 140 to verify if the account has access to the location information for the specified phone number. To ensure privacy, television device 110 will only have access to location information for particular mobile stations, e.g., for family members or all mobile stations on the same account. If access to location information is denied, the location gateway interface component 330 rejects the request with an error.

If access to the location information is granted, then the group communication server 135, using location gateway interface component 330, connects to the location gateway 335, establishes an SSL connection and sends a MLP request. The location gateway 335 obtains location information for the mobile station from the location server 165. The location gateway 335 sends a response, which includes the longitude and latitude of the mobile station identified in the LOCATION request, to the location gateway interface component 330 of the group communication server 135. The client interface component 305 of the group communication server 135 forwards the location information to the television device 110 in a LOCATION response, which is received by the broadcast video head-end input 240 and forwarded to the processor 210.

Using the longitude and latitude of the mobile station, the processor 210 of television device 110 sends a MAP request for a map image to the group communication server 135 using a MAP request. The group communication server 135 queries the mapping server 130 for a URL of an image associated with the requested longitude, latitude and zoom level. The group communication server 135 retrieves the image from the mapping server and performs any required image manipulation. Specifically, the mapping server interface component 345 downloads the GIF image to a local web directory and can optionally processes the GIF image. The mapping server interface component 345 then builds the URL to the local new web directory containing the GIF image, which is used by the television device 110 to download the GIF image. The mapping server interface component 345 then builds a response for the television device 110 including the newly formed URL in the response.

The client interface component 305 of the group communication server 135 responds to the television device 110 with the URL of the image on the group communication server 135. The processor 210 of the television device 110 then obtains the image from the group communication server 135, combines it with the location of the mobile station, and outputs, via television output 250, a map identifying a location of the mobile station identified in the request to television 115.

Referring again to FIG. 3, the dispatch communication component 320 notifies the registration and notification component 310 when a dispatch call or a dispatch call alert is received for a particular television device 110. For dispatch call alerts, the group communication server simply notifies the television device 110 of the dispatch call alert by specifying the name of the caller (if the caller's telephone number has a name alias in the Address Directory) or the caller telephone number. In the iDEN network, dispatch telephone numbers are known as Universal Fleet Mobile Identifiers (UFMIs). The dispatch communication interface component 320 also handles requests from television device 110 for sending dispatch call alerts, initiating and restarting dispatch calls using predefined audio recordings.

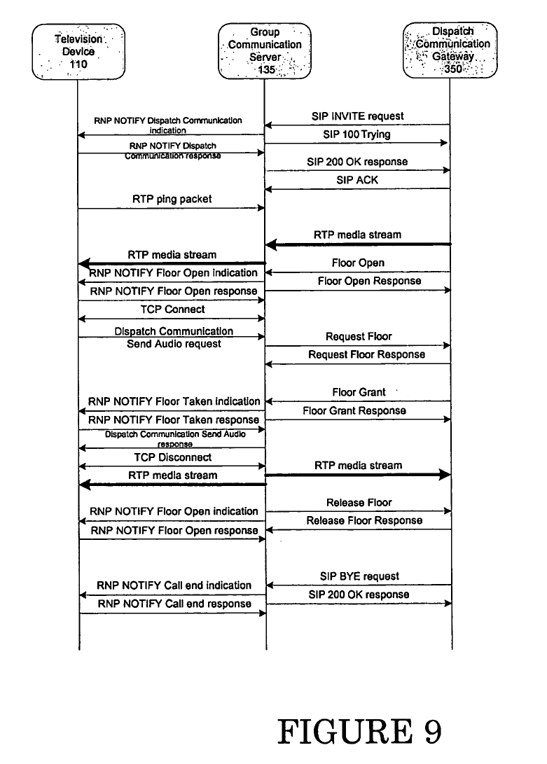

FIG. 9 illustrates an exemplary message flow of an incoming dispatch call to the television device 110 in accordance with the present invention. The message flow of FIG. 9 is for when the television device employs predefined audio messages for dispatch communication. The dispatch communication gateway 350 sends a dispatch call to the dispatch communication interface component 420 of the group communication server 135.

The group communication server 135 sends an RNP NOTIFY dispatch communication indication over the UDP channel to the television device 110. This indication also contains the IP address and port for the media on the group communication server 135. The television device 110 responds with an RNP NOTIFY dispatch communication response if it can take the call. The group communication server 135 responds to the dispatch call once the television device 110 has responded.

The television device 110 sends an RTP ping packet to the group communication server 135 so that it has an open channel through any firewalls for media. The television device 110 will periodically send this ping packet while the call is established. The dispatch communication gateway 350 streams media through group communication server 135 to the television device 110. The dispatch communication gateway 350 performs audio transcoding as needed.

When the media stream from the mobile station has stopped and the floor has been opened by the dispatch communication gateway 350, dispatch communication interface 320 of the group communication server 135 sends the television device 110 an RNP NOTIFY Floor Open. The television device 110 can then request that the group communication server 135 send audio using the dispatch communication Send Audio request. The dispatch communication interface component 320 of the group communication server 135 will request the floor from the dispatch communication gateway 350, which grants the floor to the group communication server 135. The floor control signaling between the group communication server 135 and the dispatch communication gateway 350 can be performed using any protocol, including session initiation protocol (SIP), real-time transport control protocol (RTCP), or the like.

The group communication server 135 will indicate to the television device 110 that the floor is now owned by the television device 110 using the RNP Floor Taken indication as well as complete the dispatch communication Send Audio request. The group communication server 135 will start streaming audio from the file to the dispatch communication gateway 350. To allow for easy stream decoding on the television device 110 side, the audio codec can be one which is used in the wireless network 150. The prerecorded audio clips are stored on the group communication server 135 in WAV format using the wireless network codec. The dispatch communication gateway 350 performs audio transcoding as needed. Simultaneously, audio is sent to the television device 110 so that the subscriber can hear what is being played to the mobile station. When the audio stream is complete, the dispatch communication interface component 320 of the group communication server 135 releases the floor and sends an RNP NOFITY Floor Open indication to the television device 110.

When the call times out or the mobile station disconnects, the dispatch communication gateway 350 releases the call, which releases the group communication server 135 and terminates the media session. The group communication server 135 notifies the television device 110 that the call has ended using the RNP NOTIFY Call end indication.

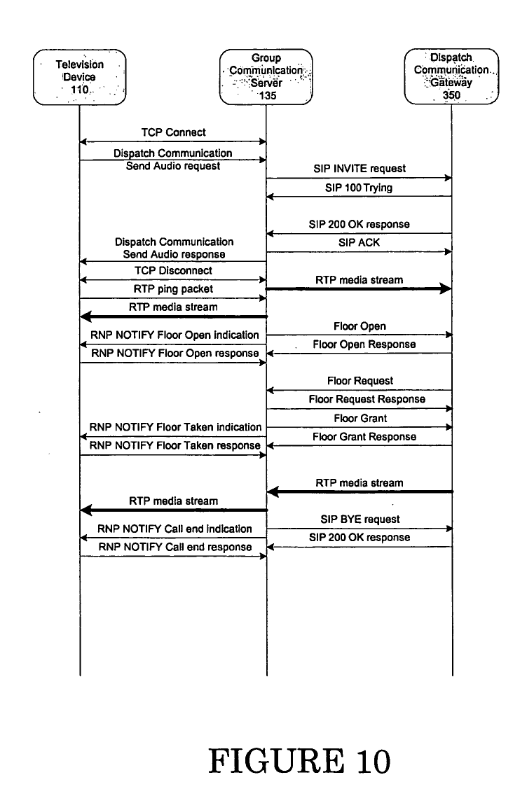

FIG. 10 illustrates an exemplary message flow for when the television device 110 places an outgoing dispatch call in accordance with the present invention. The messaging flow of FIG. 10 is for when the television device employs predefined audio messages for dispatch communications. The television device 110 connects to the group communication server 135 and sends a dispatch communication Send Audio request. The dispatch communication interface component 320 of the group communication server 135 creates a call to the dispatch communication gateway 350.

When the dispatch communication gateway 350 responds to the call, the group communication server 135 sends a dispatch communication Send Audio response to the television device 110. The television device 110 sends an RTP ping packet to the group communication server 135 so that it has an open channel through any firewalls for media. The television device 110 will periodically send this ping packet while the call is established. At the same time, the group communication server 135 starts streaming audio from the requested file to both the dispatch communication gateway 350 and the television device 110, so that the subscriber can hear what is being sent to the mobile. It should be noted that the group communication server 135 may be required to buffer audio for a short period of time until the RTP ping packet has been received. The dispatch communication gateway 350 performs audio transcoding as needed.

When the media stream is complete, the dispatch communication interface component 320 of the group communication server 135 will send a floor open to the dispatch communication gateway 350, as well as send an RNP NOTIFY Stream stop indication to the television device 110. When the mobile station wants to talk, the dispatch communication gateway 350 will request the floor from the group communication server 135 using a floor request. The floor control signaling between the group communication server 135 and the dispatch communication gateway 350 can be performed using any protocol, including session initiation protocol (SIP), real-time transport control protocol (RTCP), or the like. Once the floor has been granted, the dispatch communication gateway 350 will stream media to the television device 110 via the group communication server 135. The dispatch communication gateway 350 performs audio transcoding as needed. When the call times out, the dispatch communication interface component 320 of the group communication server 135 sends a SIP BYE request to the dispatch communication gateway 350 as well as sends an RNP NOTIFY Call ended indication to the television device 110.

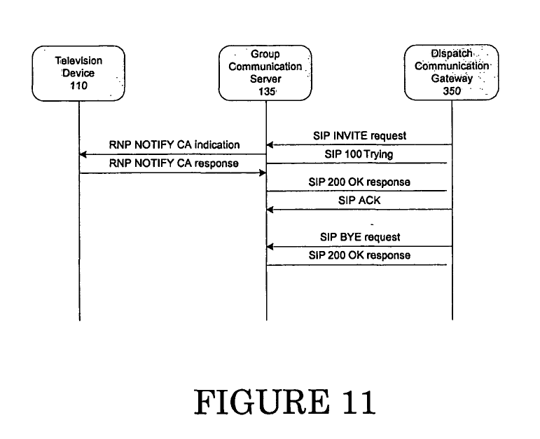

FIG. 11 illustrates an exemplary message flow of an incoming dispatch call alert to the television device 110 in accordance with the present invention. The dispatch communication gateway 350 sends a dispatch call alert to the dispatch communication interface component 320 of the group communication server 135. The group communication server 135 sends an RNP NOTIFY CA indication to the television device 110 which responds with an RNP NOTIFY CA response. If the television device 110 responds, the group communication server 135 responds positively to the SIP INVITE request from the dispatch communication gateway 350. The dispatch communication gateway 350 completes the call alert by sending a SIP BYE transaction to the group communication server 135. Television device 110 can initiate a dispatch communication when the call alert is selected from a graphical user interface (GUI).

Referring again to FIG. 3, the user setting component 355 facilitates access to the user database 140. The user database 140 stores the account ID, e-mail address assigned for the account (for incoming MMS and 2-Way messages). The user database 140 also stores the ‘Address Directory Table’ containing name Aliases, phone numbers (to retrieve location information), dispatch calling number identifiers (to initiate dispatch calls and dispatch call alerts), e-mail address—optionally required for sending MMS messages to PCs or other television devices (not illustrated). The user database 140 also stores the ‘Message List Table’ (containing e-mail messages IDs and read/unread status), the ‘Message Notified Table’ (containing e-mail message IDs for messages of which the television device 110 was already notified), and a ‘Predefined Objects Table’ (containing Mime type of the object, Object, text for MMS and 2-Way messages, and URLs to audio clips for dispatch calls. The user database 140 can include user configurable preferences such as visual and/or audio notification of incoming communications, privacy mode (in which all incoming dispatch communications are rejected), and the like.

The user settings component 355 is accessed by client interface component 305 when the television device 110 requests account settings from the ‘Address Directory Table’, and the television device 110 requests account settings from the ‘Predefined Objects Table’. The user setting component 355 is also accessed by location gateway interface component 330, which checks if the account has access to location information for a given phone number (from the ‘Address Directory Table’), in-box interface component 315 to access the ‘Message List Table’, and management interface component 360 to create accounts and access account information.

The management interface component 360 allows a network operator and a user to manage accounts using a web browser and store account settings in the user database 140, via computer 365. The operator can also configure the service by specifying the addresses of external servers. The web server is secured using SSL.

Using the services of the management interface component 360, an operator can create accounts, delete accounts, add phone numbers which will yield location information to a particular account, assign an account e-mail address for incoming 2-way and MMS messages, assign an account dispatch call identifier, such as a UFMI, for incoming dispatch calls. Creating an account includes adding the unique account ID to the ‘Account Table’ and creating the ‘Address Directory Table’, ‘Predefined Object Table’, ‘Message List Table’, and ‘Message Notified Table’. The ‘Address Directory Table’ may optionally be populated with the phone numbers which yield location information.

The operator has the ability to configure the service by specifying the address of the location gateway 335, the address of the dispatch communication gateway 350, the address of the SMTP/POP server 325 (for incoming messages), the address of the MMS/2-Way messaging gateway 370 (for outgoing MMS/Text messages), and the address of the mapping server 130.

By accessing the management interface component 360, a user can add/edit address directory entries to the account by specifying name alias, phone number or E-mail address, and dispatch call identifier. The user can also delete address directory entries from the account, add/edit/delete predefined text messages for MMS and 2-Way messages, add/delete predefined audio clips to be used in dispatch calls, upload audio clips from a PC, or manage the message Inbox.

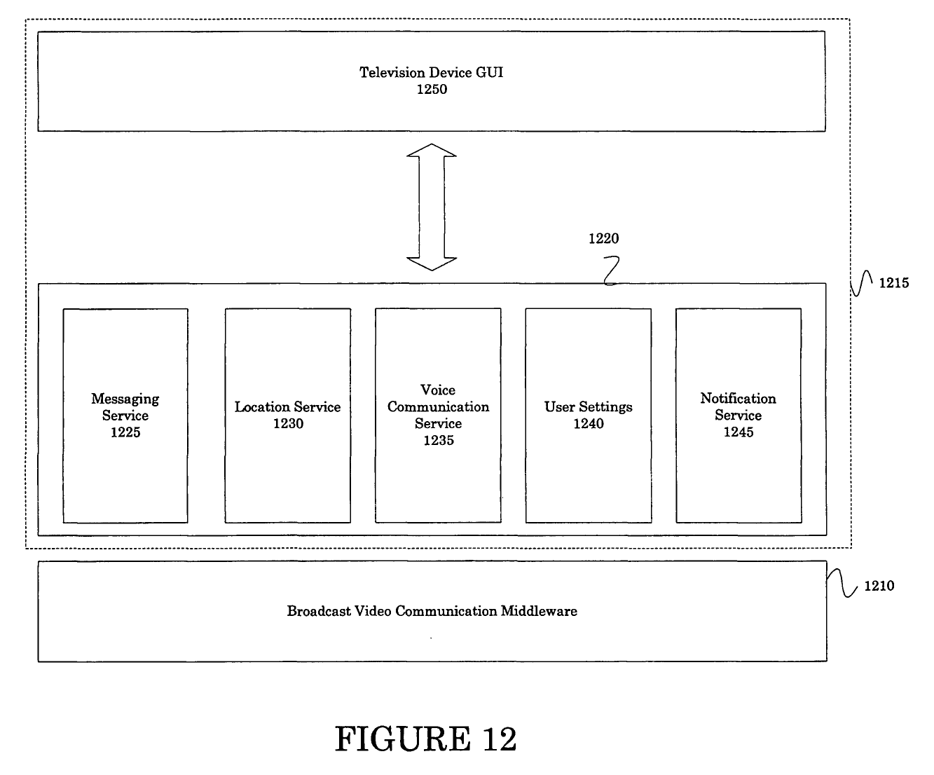

FIG. 12 is a block diagram of an exemplary software architecture of a television device in accordance with the present invention. A broadcast video communication middleware 1210, such as OCAP middleware, provides a Java-based software platform for television device applications. The OCAP middleware comprises Java and native C++ code that implements libraries. These run on top of a Java Virtual Machine (JVM).

The television device application 1215 can be implemented almost entirely in Java using APIs that are part of the OCAP 1.0 specification. However, in some cases missing features in the OCAP implementation can be achieved using extensions to the specification, which are implemented using native code (C++) that exposes additional Java APIs to the television device application 1215.

The television device application 1215 comprises a television device library 1220, which provides the networking engine that implements all communication with the servers, and a television device GUI 1250. The television device GUI 1250 application can rely on APIs present in the OCAP specification or provided by the television device library 1220. The television device library 1220 is implemented as much as possible only using OCAP APIs. However, to work around limitations in the current OCAP implementation, some portions of it may directly access native portions of an operating system running on the television device 110.

The messaging service module 1225 interfaces with the group communication server 135 to provide the television device GUI 1250 layer with services for sending text messages, forwarding received messages (with user text additions), retrieving in-box messages and attachments, and deleting messages.

The location service module 1230 interfaces with the group communication server 135 to provide the television device GUI layer 1250 with services for retrieving location information of one or more targets retrieving maps based on target location, and retrieving new map due to pan & zoom interactions.

The voice communication service module 1235 interfaces with the group communication server 135 to provide the television device GUI layer 1250 with services for incoming dispatch calls or call alert notifications, outgoing dispatch calls or call alert initiations, and wrapper class for RTP media streaming.

The user settings module 1240 interfaces with the group communication server 135 to provide the television device GUI layer 1250 with services for retrieving user settings and Address Directory information from the group communication server 135. The notification service module 1245 interfaces with the group communication server 135 to provide the television device GUI layer 1250 with services for registration and keep alive interactions with the server, incoming MMS/Text message notifications, incoming dispatch call alert or call notifications, dispatch call status notifications (e.g., talker token change), and server configuration change notifications. Although the software architecture has been described in connection with OCAP middleware, any other middleware can be employed, as desired.

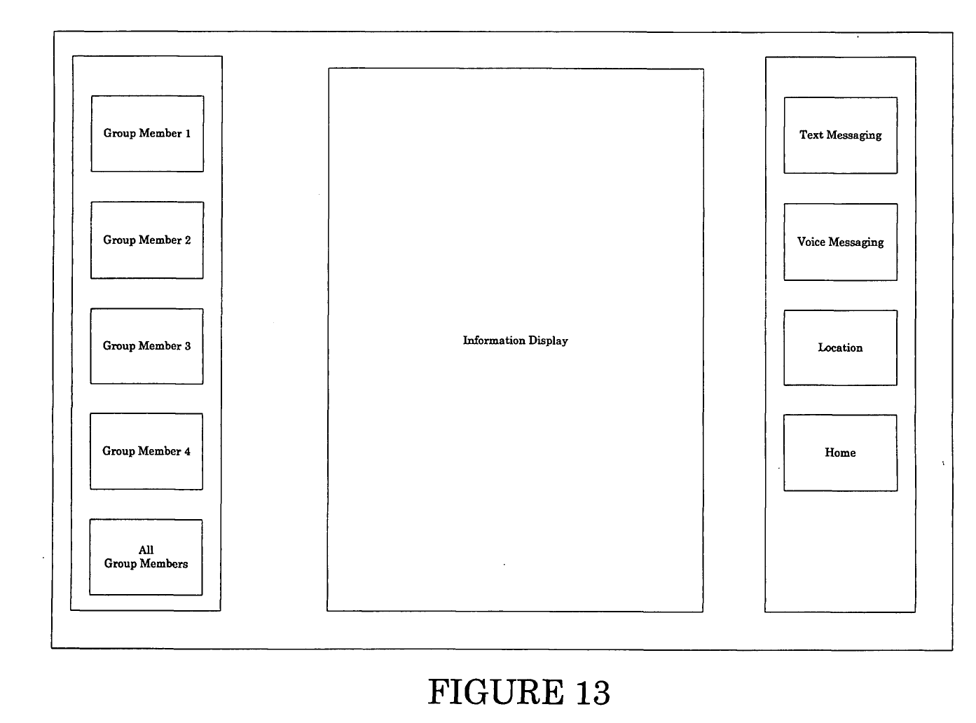

FIG. 13 is an exemplary GUI displayed on a television for communicating information between a television device and a mobile station in accordance with the present invention. The GUI, or information for generating the GUI, can be provided to the television device 110 either in-band, as part of a particular channel, or out-of-band, unassociated with any particular channel. As illustrated in FIG. 13, the GUI includes a navigable buttons corresponding to each member of the group, and one navigable button corresponding to all group members. The center of the GUI includes an information display area, which displays maps, and other information used for communicating with wireless stations. The right side of the GUI includes buttons for selecting text messaging, voice messaging, location, and the home screen. The GUI can also provide visual notifications of incoming communications. The GUI illustrated in FIG. 13 is merely exemplary, and other GUIs can be employed with the present invention.

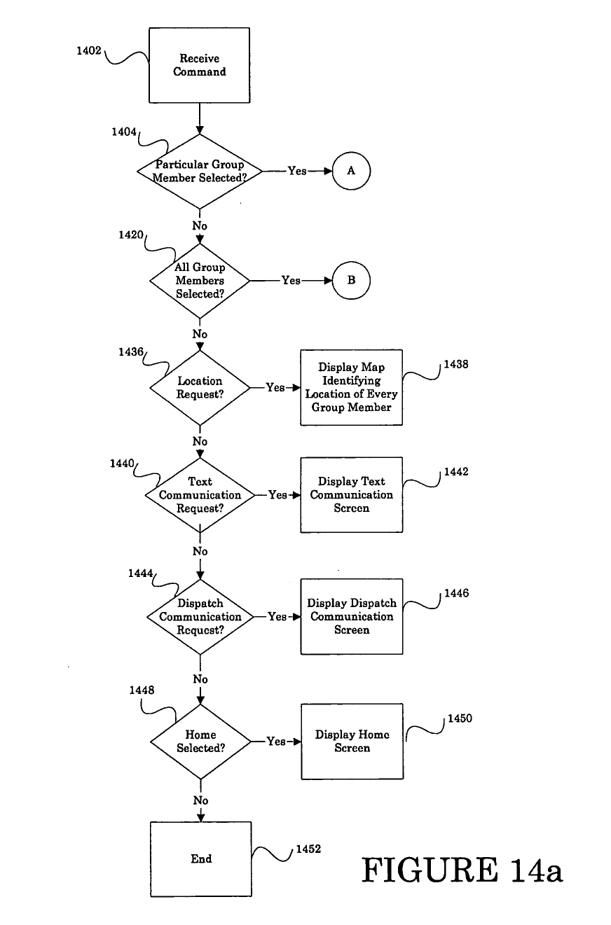

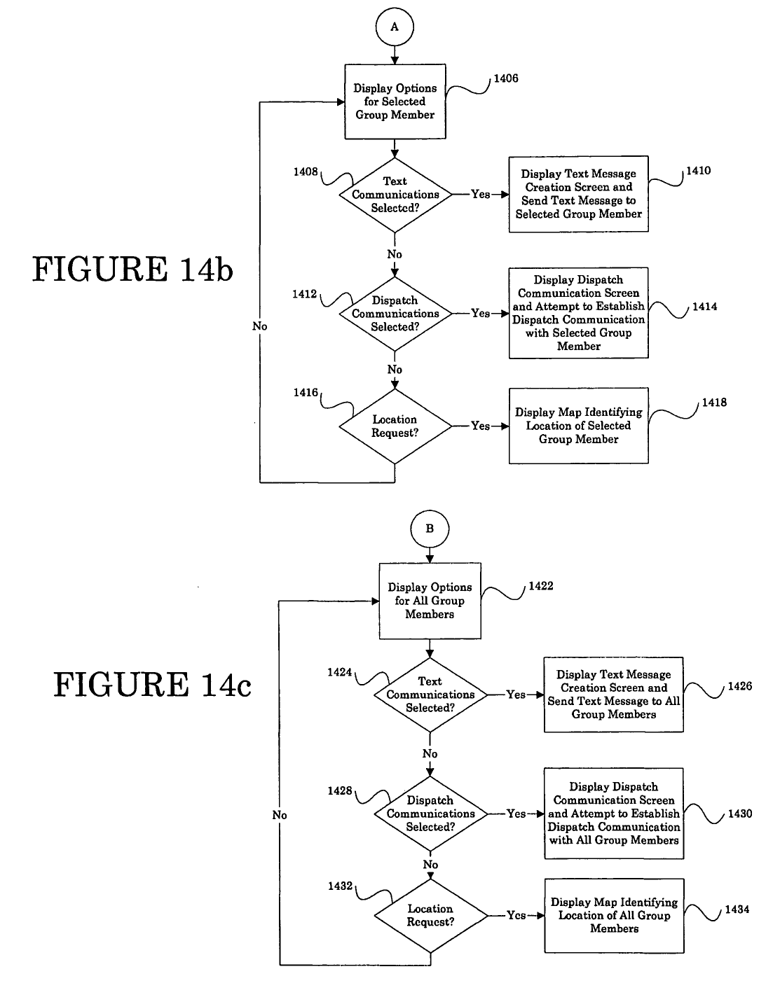

Operation of the GUI illustrated in FIG. 13 will now be described in connection with FIGS. 14a-14c. When the television device 110 receives a command (step 1402 ), the processor 210 determines whether the command selected a particular group member, i.e., one of the group member buttons (step 1404 ). If a particular group member is selected (“Yes” path out of decision step 1404 ), then a submenu is presented providing options for sending a text or dispatch communication message to the selected group member, or requesting the location of the selected group member (step 1406 ). If text communications is selected from the submenu (“Yes” path out of decision step 1408 ), then the information display region of the GUI displays a text message creation screen, and the television device will send the text message (step 1410 ). If dispatch communications is selected from the submenu (“Yes” path out of decision step 1412 ), then the information display portion of the GUI displays the dispatch communication screen and the television device 110 attempts to establish a dispatch communication with the selected group member (step 1414 ). If a location request is selected from the submenu (“Yes” path out of decision step 1416 ), then the information display portion of the GUI outputs a map identifying the location of the selected group member (step 1418 ).

When the all group members button is selected from the GUI (“Yes” path out of decision step 1420 ), then a set of options similar to that described above in connection with the selected group member, i.e., steps 1406 - 1418, is displayed. Specifically, if the all group members button is selected (“Yes” path out of decision step 1404 ), then a submenu is presented providing options for sending a text or dispatch communication message to all group members or requesting the location of all group members (step 1422 ). If text communications is selected from the submenu (“Yes” path out of decision step 1424 ), then the information display region of the GUI displays a text message creation screen, and the television device will send the text message to all group members (step 1426 ).

If dispatch communications is selected from the submenu (“Yes” path out of decision step 1428 ), then the information display portion of the GUI displays the dispatch communication screen and the television device 110 attempts to establish a dispatch communication with all group members (step 1430 ). If all of the group members are members of a predefined dispatch group, then a dispatch group call is initiated using a single dispatch call identifier. However, if all of the group members are not members of a predefined dispatch group, then a selective dynamic dispatch group call is initiated using the dispatch identifiers of each of the group members. If a location request is selected from the submenu (“Yes” path out of decision step 1432 ), then the information display portion of the GUI outputs a map identifying the location of all of the group members (step 1434 ).

If the received command is a location request (“Yes” path out of decision step 1436 ), then a map identifying the location of each group member is displayed (step 1438 ). If the received command is a text communication request (“Yes” path out of decision step 1440 ), then a text communication screen is displayed (step 1442 ). The text communication screen can include an in-box screen identifying received text and MMS messages, and missed dispatch calls and dispatch call alerts. The text communication screen can also provide for the creation of text and/or MMS messages to mobile stations, or any other device associated with an electronic mail address. The subject and body of the messages can be previously created (either by the user or by the network operator), or can be created by the user.

If the received command is a dispatch communication request (“Yes”0 path out of decision step 1444 ), then the dispatch communication screen is displayed (step 1446 ). The dispatch communication screen provides a GUI for a user to initiate a dispatch communication to a mobile station. If the received command is the selection of the home screen (“Yes”path out of decision step 1448 ), then the home screen is displayed (step 1450 ). If the received command is not recognized, then the processing ends (step 1452 ).

Although exemplary embodiments of the present invention have been described as providing dispatch communications between mobile stations and a television device, interconnect voice or data communications can also be provided. Moreover, although the broadcast video head-end has been described in connection with a cable network, the broadcast video head-end can be a terrestrial over-the-air or. satellite broadcast video head-end. Additionally, or alternatively, the broadcast video head-end can be an Internet Protocol Television (IPTV) head-end.

Exemplary embodiments have been described above as providing location and dispatch communication services to a television device coupled to a broadcast video head-end. However, other embodiments of the present invention can provide such services to mobile stations, such as smart phones, or to computers, such as desktop or laptop computers. For example, the user interface illustrated in FIG. 13 can be provided on a display of a mobile station or computer, such that a user of the mobile station or computer can obtain the location or dispatch communication services using the user interface.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A television device, comprising:
a first input, which receives radio frequency signals from a broadcast video head-end;
an output, which outputs video information to a television display device;
a second input, which receives information from a remote control device; and
a processor, which receives the information from the remote control device, sends a request to the broadcast video head-end based on the information received from the remote control device, and outputs a response based on information received from the broadcast video head-end, wherein the information received from the remote control device is a request for a location of a mobile station, or a request for dispatch communications with a mobile station.

2. The television device of claim 1, wherein the information received from the remote control device is a select command, and the processor determines whether a request for a location of a mobile station or a request for dispatch communications with a mobile station is identified on a graphical user interface output on the television display device when the select command is received.

3. The television device of claim 1, wherein when the information is a request for a location of a mobile station, the processor receives a location of the mobile station, receives a map corresponding to the location, and provides a map identifying the location of the mobile station to the output.

4. The television device of claim 1, wherein the request is a request for locations of a plurality of mobile stations, and the processor provides the output with a map identifying the location of each of the plurality of mobile stations.

5. The television device of claim 1, wherein the television device is an integral component of the television display device.

6. The television device of claim 1, wherein the television device is an external peripheral component, coupled to the television display device.

7. The television device of claim 1, wherein the broadcast video head-end is a cable broadcast video head-end.

8. The television device of claim 1, wherein the broadcast video head-end is a satellite broadcast video head-end.

9. The television device of claim 1, wherein the broadcast video head-end is an Internet Protocol television (IPTV) video head-end.

10. The television device of claim 1, wherein when the processor receives a request for dispatch communications with a mobile station, the processor also receives an identifier corresponding to a prerecorded audio clip to be forwarded to the mobile station during the dispatch communication.

11. A communication server for providing communications between a television device and a mobile communication device, comprising:
a television device interface, which receives a request from a television device for a location of a mobile station;
a wireless network interface, which transmits a request to a wireless network for the location of the mobile station; and
a mapping server interface, which transmits a request to a mapping server for a map corresponding to the location of the mobile station,
wherein the television device interface provides the television device with information for displaying a map identifying the location of the mobile station.

12. The communication server of claim 11, wherein the television device interface comprises a client interface component and a registration and notification component.

13. The communication server of claim 12, wherein the registration and notification component notifies the television device of received electronic mail, received text messages, or missed dispatch communications.

14. The communication server of claim 11, wherein the wireless network interface comprises:
a location gateway interface, which communicates with a location server of the wireless network; and
a dispatch communication gateway interface, which communicates with a dispatch communication gateway of the wireless network.

15. The communication server of claim 14, wherein the dispatch communication gateway interface provides the dispatch communication gateway with a prerecorded audio stream as part of a dispatch communication.

16. The communication server of claim 14, wherein the dispatch communication gateway interface provides the television device interface with information received from the dispatch communication gateway.

17. The communication server of claim 16, wherein the information received from the dispatch communication gateway includes audio and dispatch communication floor control information.

18. A method for displaying information related to a mobile station, comprising the acts of:
receiving, by a television device, a request for location information regarding a mobile station;
transmitting, by the television device to a broadcast video head-end, the request for location information;
receiving, by the television device from the broadcast video head-end, information associated with the location of the mobile station; and
displaying a map, which identifies the location of the mobile station.

19. The method of claim 18, wherein when the request is for location information of a group of mobile stations, the displayed map identifies the location of each member of the group of mobile stations.

20. The method of claim 18, further comprising the acts of:
receiving, by the television device, a request to change a scale of displayed map;
transmitting, by the television device to the broadcast video head-end, a request for a new map;
receiving a new map from the broadcast video head-end, which corresponds to the changed scale request; and
displaying the new map, which identifies the location of the mobile station.

21. The method of claim 18, further comprising the acts of:
receiving, by the television device, a request to access received dispatch communications;
displaying information related to the received dispatch communications; and
outputting a selected one of the received dispatch communications.

22. Machine readable code, which is executed on a processor, comprising:
a television device graphical user interface component, which provides a graphical user interface to a display;
a television device library, which includes a location service for identifying a location of a mobile station in a wireless network; and
broadcast video communication middleware, which interfaces the television device library with a broadcast video head-end.

23. The machine readable code of claim 22, wherein the television device library further comprises a voice communication service for providing the television device graphical user interface component with information related to dispatch communications.

24. The machine readable code of claim 22, wherein the television device library further comprises a messaging service for providing the television device graphical user interface with services for sending and receiving text messages.

25. The machine readable code of claim 22, wherein the broadcast video communication middleware is an OpenCable Application Platform (OCAP) compatible middleware.
